(19) United States
(12) Patent Application Publication
(10) Pub. No.: US 2026/0098569 A1
(43) Pub. Date: Apr. 9, 2026

(54) Shaped Brake Disc

(71) Applicants: Spencer Edwin Daw, Agoura Hills, CA (US); Molly Sharon Daw, Agoura Hills, CA (US); Duncan Howard Daw, Agoura Hills, CA (US); Dylan Mitchell Daw, Agoura Hills, CA (US)

(72) Inventors: Spencer Edwin Daw, Agoura Hills, CA (US); Molly Sharon Daw, Agoura Hills, CA (US); Duncan Howard Daw, Agoura Hills, CA (US); Dylan Mitchell Daw, Agoura Hills, CA (US)

(21) Appl. No.: 18/911,007

(22) Filed: Oct. 9, 2024

(51) Int. Cl. F16D 65/12; F16D 55/22; F16D 69/00

(52) U.S. Cl. CPC F16D 65/127; F16D 55/22; F16D 2069/004

(57) ABSTRACT

A disc for a disc-brake as used in a vehicle. The disc includes shaped pad contact areas on either or both sides of the disc where the brake pads make contact with the disc during braking. The shaped nature of the disc consists of elevated and/or depressed features relative to the flat sides of the disc in the pad contact area, generally in the shapes of sloped ridges and/or valleys, which run in a circular manner around the disc's rotational axis when viewed from the said disc's side view perspective and have an elevation differential of generally 1/32 to ½ inch.

### BACKGROUND OF THE INVENTION

This invention relates to the disc in a vehicle disc-brake system and more particularly to the problem of needing additional friction contact surface area on a disc that is otherwise constrained by diameter limitations.

The disc of a disc-brake system is a generally flat circular metallic plate that is connected at its centerpoint to a road wheel at its centerpoint such that they are both attached to a common axle or axis around which they jointly and synchronously spin. When the road wheel turns the attached disc must also turn and if the said disc is caused to slow or stop the connected road wheel must synchronously slow or stop. The manual forced slowing or stopping of the disc is the braking effect.

Manual forced slowing of the disc is accomplished through the use of brake pads (friction agents) using a clamping motion to simultaneously apply equal and opposing forced sliding friction pressure onto the flat sides of the spinning disc. This clamping motion requires two separate pad contact areas and two separate pads, that is, one pad contact area and one pad for each side of the clamped disc. The mechanism that holds and deploys the said clamping pistons and pads is referred to as a brake caliper and there is usually one brake caliper per disc.

The pad contact areas of the disc begin at the outside edges (perimeter) of the flat sides of the disc and then extend inward and toward the disc's centerpoint thereby forming about a 2 or 3 inch wide annular belt, or ring, around the outermost 2 or 3 inches on each side of the disc. These pad contact areas are smooth, flat, surfaces where the complementary and equally smooth, flat, and approximately 2 or 3 inch high and 3 or 4 inch wide (long) brake pads make pressurized sliding friction contact with the spinning disc in the said annular pad contact area to accomplish the said braking effect.

Vehicle disc-brake systems are a mature technology with a rich history of research and development which has been done, and continues, to provide optimum performance for both the pad and the disc including configurations, force pressures, sizes, and compositions of components, for efficiency, usability, and durability. Regarding the brake disc itself there have been refinements and advances to improve disc cooling and to clear pad residue via holes or slots in the disc itself and roughing or scoring of the disc's pad contact area to stabilize the brake pad and thereby quell or minimize pad squeal, judder and knocking and to generally improve brake feel.

Disc-brake discs are produced in many sizes to fit different vehicle applications and their braking requirements. The specific measurements used herein are not meant as required or even suggested regarding sizes but as an aid to communicating a concept. This invention is not pertaining to manufacturing processes, the operation of disc brakes in general or to specific materials but is limited to the shaping of the pad contact area(s) of the brake disc itself. The disc-brake system can be dual piston, floating single piston, or other and can include split disc, solid disc or other configurations.

### SUMMARY OF THE INVENTION

A primary objective of this invention is to provide a disc for a disc-braking system that increases that systems efficiency and efficacy in engaging, maintaining and sustaining braking within the systems original basic framework by altering portions of the system's disc to create greater available pad contact surface area(s) within the disc's original pad contact boundary area(s).

The increasing of a disc's available pad contact surface area is accomplished by shaping the disc's pad contact surface area(s). Shaping is the providing of a raised and/or a depressed feature or features in, and instead of, the traditionally flat pad contact surface area(s) of the disc. Said shaping can be provided by any means of construction or modification, including, but not limited to forging, casting or otherwise, that results in a disc having a shaped configuration of its pad contact area(s) as described herein.

The said raised and/or lowered features of the disc are generally comprised of features that are arced and/or sloped less than 90 degrees relative to the disc's flat side(s) and may, for example, present in the form of a charted periodic function wave, or waves, when viewed from the disc's cutaway edge view perspective as will be more fully explained in the later drawings and descriptions. Not all raised and/or lowered features in a disc's pad contact area result in an increased available pad contact surface area because those certain features providing that greater pad surface area may not provide surface area that is available for pressurized pad contact. Those shaped features that do not increase the available pad contact surface area of the disc are not included in this invention.

The shaped disc features included in this invention are comprised of generally arced and/or slanted raised and/or lowered elements that will present in the configuration of a ridged (and/or depressed) circle or concentric circles, relative to the rotational axis of the disc, and thereby encircling the disc's centerpoint when viewed from the disc's side view perspective. If the shaped disc includes more than one raised or depressed feature then those features will present in the form of declining concentric circles from the perimeter of the disc toward its centerpoint. The disc's shaped features cannot be in the form of a spiral, that is, as a continuous declining radius depression (valley or valleys) and/or rise (peak or peaks) from the disc's perimeter toward its centerpoint as that continuous declining radius feature would not mesh with the fixed brake pad(s), resulting in a lesser pad contact and/or excessive wear.

A primary benefit of a shaped disc pad contact surface area is the ability to generally employ the same proven concepts, materials and hardware as in a traditionally configured disc-braking system while also being able to locate the equivalent pad contact surface area as provided by a traditional disc configuration into a smaller pad contact boundary area toward the more efficient outer perimeter extremity of the shaped disc's pad contact area.

Another benefit of a shaped disc pad contact surface area is the ability to generally use the traditional disc-brake system's components while also being able to use shaping to increase the available pad contact surface area within the disc's original pad contact boundary area thus allowing for the use of less pressure per square inch of actual pad contact in order to obtain the same total force pressure as provided by the original flat pad/disc within the same boundary area.

Other advantages and constructions of this invention will become apparent from the following detailed descriptions of some preferred embodiments when considered with the accompanying drawings.

### BRIEF DESCRIPTION OF THE DRAWINGS

FIG. 1 is a diagrammatic frontal view of a generic automotive disc-braking system including the orientation and inclusion of an edge view perspective of its disc.

FIG. 2 is a diagrammatic half section cutaway and partially revolved perspective showing of the outboard side of a shaped brake disc with its upper right quadrant removed thereby simultaneously showing both its outboard side and an exposed cut half section view of its edge.

FIG. 3 is a diagrammatic side view of a shaped disc showing its shaped features in their necessarily concentric circular nature relative to its rotational axis and includes showing the positional relation and interaction of the shaped disc with a complementary shaped brake pad.

FIG. 4 is a magnified diagrammatic view of the top half of FIG. 1 but now including the as modified disc from FIG. 2 as the disc being shown from the same edge view perspective as the disc in FIG. 1. Removing the disc's upper right quadrant allows viewing the disc's shaped features from an edge view perspective which said shaped features would otherwise be hidden or obscured by the arced nature of the shaped peaks.

The disc is shown with the same triangle wave shaped features on its outboard side as in FIG. 2 but its inboard side is shown with a sine wave shaped pad contact area.

FIG. 5 is a similar edge view as FIG. 4, that is, using a disc with a removed upper right quadrant and having alternative shaped features in the pad contact areas, that is, a repeating square wave type shaping on its outboard side and a single convex shaped feature on its inboard side.

### DETAILED DESCRIPTION OF A FEW PREFERRED EMBODIMENTS

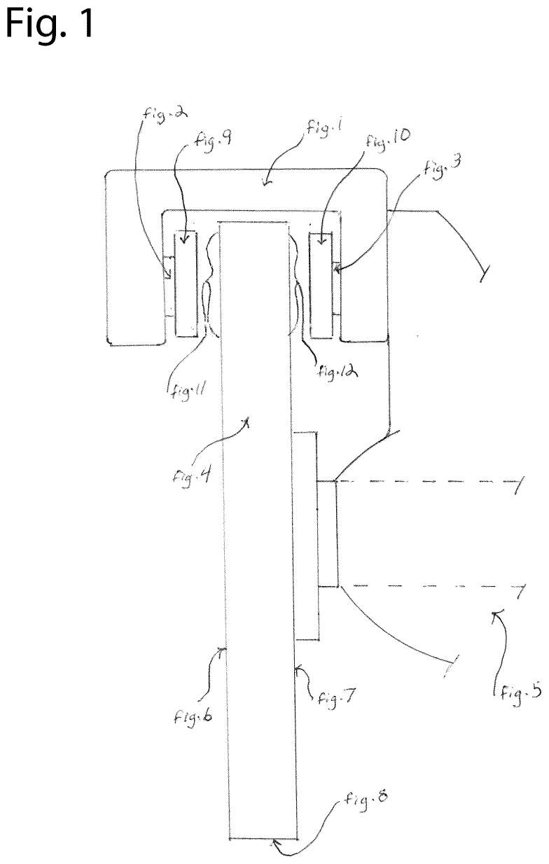

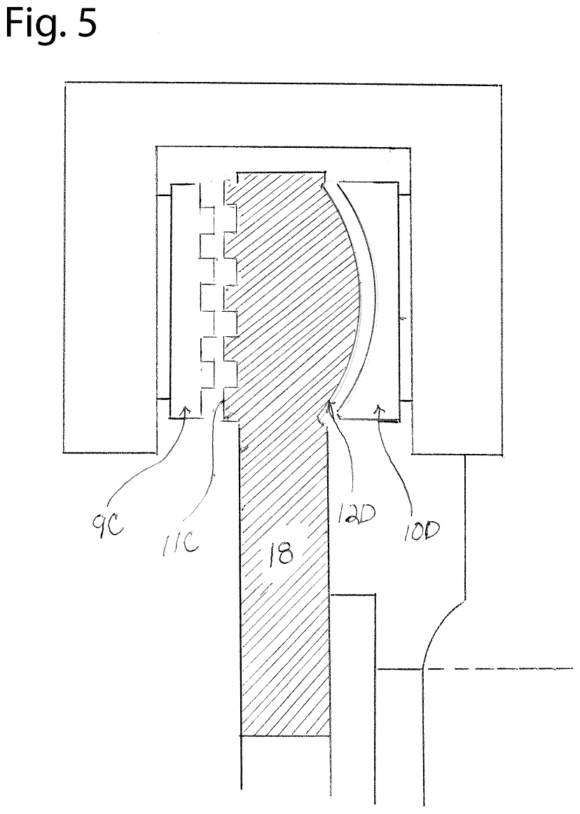

FIG. 1 depicts a generic automotive disc-braking system and is included for background, perspective and to illustrate the general operation of a disc-brake system including a caliper 1, being the mechanism which houses and deploys two separate and opposing sliding pistons, 2 and 3, which simultaneously forcefully extend when braking and thereby apply a clamping effect against the disc, 4, via the friction agents (brake pads) 9 and 10, attached to the tips of the said pistons, causing the slowing or stopping the disc's spinning. It includes showing the non-rotational fixed nature of the caliper, and therefore the brake pads, onto the hub/axle housing of the vehicle as FIG. 5. The disc is further described as having an outboard side 6 and an inboard side 7 and also an edge 8.

The disc (4) is further defined as having pad contact areas that are the specific areas of the disc that are or may be contacted by the pads during braking and are denominated as 11 (on outboard side 6) and 12 (on inboard side 7). FIG. 1 shows the rotor and brake pads in a non-pressurized/non-friction state and therefore a non-braking state.

The shown FIG. 1 is a dual piston caliper and one-piece disc but this invention pertains to any disc/piston configuration including floating one-piston calipers and/or split discs.

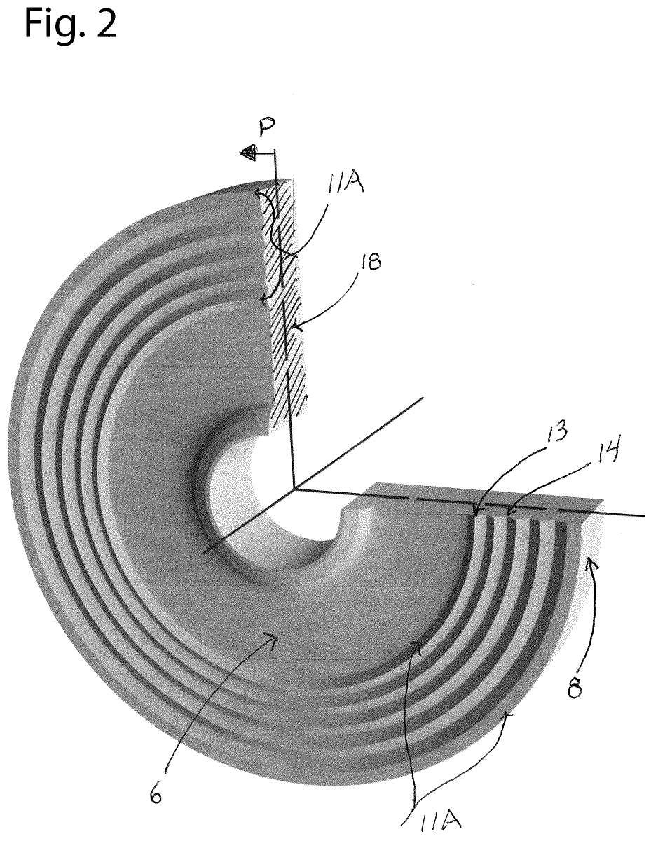

FIG. 2 shows a half section cut and partially revolved perspective of a shaped disc with triangular wave shaped features in the disc's outboard side's traditionally flat pad contact area 11. The formerly flat pad contact area 11 is now identified as pad contact area 11A identifying the pad contact area as being shaped with triangle shaped waves as further explained herein. The disc has been revolved about 25 degrees so that the outboard side 6 and the edge of the rotor 8 are concurrently visible. A “pie slice” segment comprising the disc's upper right quadrant has been removed as indicated by the cut line P, thereby exposing the disc's vertical inner surface 18 (identified via section lines) showing the hidden triangular wave shaped pattern of the pad contact area. The triangular wave shaped features are further identified as having peaks, identified as 13 and valleys as 14. The drawing shows the nature of the triangular wave features as being a series of concentric declining alternating peaks and valleys completely encircling the rotor within the annular ‘belt’ of its pad contact area. The said peaks and valleys form declining concentric circles and are not one declining ridge or valley. Further, the triangular wave type shaped pad contact area is occupying just the outermost, that is, toward the outer perimeter, 1 to 1½ inches of the traditionally flat pad contact boundary area instead of occupying the full traditional 2 to 3 inches of the disc as in a traditional flat pad contact area disc.

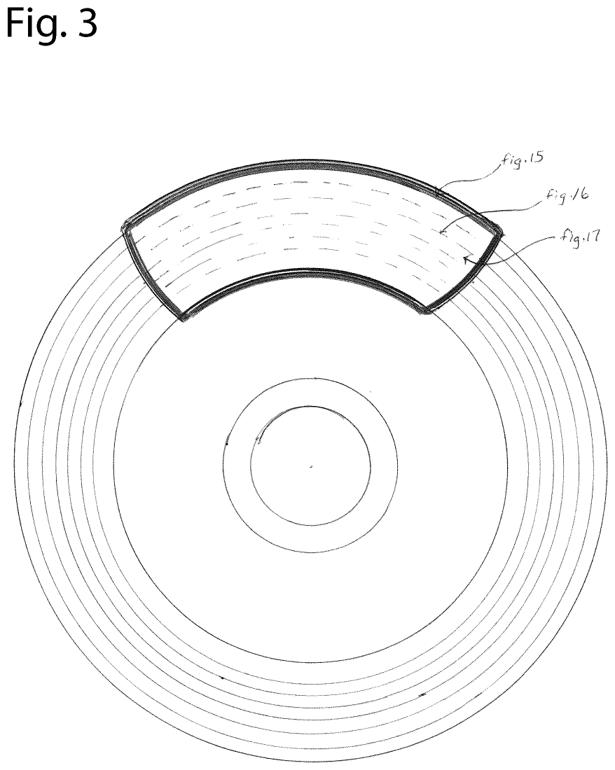

FIG. 3 is a side view of a triangular wave type shaped rotor showing the declining concentric circular nature of the disc's shaped features in the pad contact area with the lines representing triangular wave type peaks 13 and the blank spaces between the said peaks representing the valleys 14 between the said peaks. This illustration also shows a complementary triangle wave feature shaped brake pad 15 placed at the 12:00 o'clock position in the pad contact area of the disc which generally depicts the relationship of the said pad and rotor while in use. This brake pad 15 is shaped with the same and corresponding triangular wave features as the rotor but is complementary, that is, the features of the rotor and the pad mesh when one is placed atop the other as in this figure. The pad's broken concentric lines are its (the pad's) valleys 16 in its reverse and complementary triangular wave configuration. The pad's blank spaces 17, that is, the space between its valleys 16, are the pad's peak features.

The shaped features of the pad necessarily run in the form of an arc in order to mesh with the circular nature of the shaped disc's features of its pad contact area.

A complementary shaped pad is the much preferred adjunct to a shaped disc but if the disc's shaped features are minimal (little arc/slant and/or little height differential) a traditional flat pad might be able to erode to mesh with the shaped disc albeit sub optimally. For this reason, the shaped pad is submitted as a separate petition and claim.

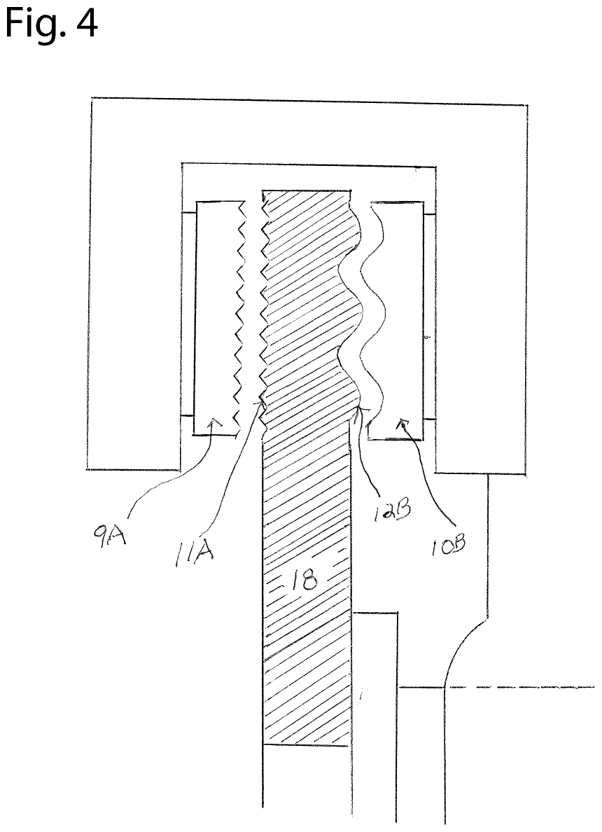

FIG. 4 is generally a view of a portion of the upper half of the braking system FIG. 1 with an emphasis on the pad contact areas 11 and 12 of the disc 4 and also showing the brake pads 9 and 10.

In this depiction the original generic disc 4 has been replaced by the modified disc as described in FIG. 2 such that the visible portion of the disc is a half section cut view of the exposed inner vertical Y axis surface 18 as identified by section lines, remaining after the removal of the disc's upper right quadrant. This edge view is a 90 degree revolved view relative to a flat side view.

The former flat pad contact areas 11 and 12 of the disc 4 in the traditional generic disc braking system FIG. 1 have been replaced on the outboard side by a triangular wave type shaped disc contact area now as 11A while the inboard side of the disc's pad contact area has been replaced with a sine wave type shaped pad contact area on its disc contact area now as 12B indicating a sine wave type pad contact area on the inboard side.

Complementary shaped brake pads are shown as 9A for the outboard triangle wave pad and 10B for the inboard sine wave pad.

FIG. 5 is a variation of FIG. 4 including the use of the modified disc of FIG. 2 with its upper right quadrant removed in order to show an edge view of the shaped nature of the disc's pad contact area on the exposed vertical Y axis exposed surface 18. In this depiction the outboard side's pad contact area has been replaced by a square wave type shaped pad contact area, now 11C. The square wave is helpful in further defining the concept of increased available pad contact area in that a ‘square’ wave is theoretically neutral or very nearly neutral with regards to increasing available pad contact areas. In practice, a complementary shaped ‘square wave’ pad could compress or distort under pressure or torque and thereby impact the 90 degree walls of the square wave disc features or the torsional drag from the fixed pads might result in the shaped features making side contact under some braking circumstances. To the extent that the available pad contact area is increased a ‘square wave’ style shaped disc is included in this petition and claim.

The inboard side in this depiction has a single convex shaped feature in its pad contact area as 12D. This embodiment illustrates that a repeating feature is not required.

Complementary shaped pads are suggested and shown as 9C for the square type outboard pad and 10D for the inboard complementary concave feature pad.

The above illustrations are presented as some examples of preferred embodiments that exemplify the crux and spirit of the invention but they are not exclusive and those skilled in the art may present further variations and modifications so long as they don't deviate from the spirit or scope of the invention.

What is claimed is:

1. A disc for a vehicle disc-brake system, generally having two fixed non-rotating and opposing brake pads which, during braking, make pressurized sliding friction contact with the sides of a spinning disc in a clamping motion to slow or stop the said disc, thereby slowing or stopping the connected vehicle, with said disc comprising, on one or both sides, in the area(s) of the disc which are contacted by the brake pad(s) during braking:
one or more raised and/or depressed generally sloping and/or arcing features of 90 degrees or less relative to the disc's flat side(s) and generally comprising a peak or peaks and/or a valley or valleys, which said features are configured to provide greater available disc/pad contact surface area than is provided by a flat disc/pad configuration; and
which said sloping and/or arcing features may be, by way of example but not limited to being, in the general shape of a triangular wave, sine wave or other charted periodic function wave(s) when viewed from the said disc's mounted cross section edge view perspective; and
with said raised and/or lowered feature(s) comprising a circular ridge and/or valley configuration or a series of declining concentric circular ridges and/or valleys from the disc's perimeter edge toward and relative to its rotational axis and therefore encircling the disc's centerpoint when viewed from a side surface perspective; and
with said shaped features comprising an elevation differential of generally 1/32 inch to ½ inch; and
with said disc being comprised as above by virtue of original construction, modification or otherwise, by cast, forge or other manufacturing or production processes, and being inclusive of any and all construction methods, modifications, and/or materials.
